(19) United States
(12) Patent Application Publication
(10) Pub. No.: US 2007/0180223 A1
(43) Pub. Date: Aug. 2, 2007

(54) Computer system and method of booting the system

(75) Inventor: Akira Tanaka, Mitaka-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/657,651

(22) Filed: Jan. 25, 2007

(30) Foreign Application Priority Data
Jan. 31, 2006 (JP) 2006-023614

(51) Int. Cl. G06F 9/00

(52) U.S. Cl. 713/2

(57) ABSTRACT

A sub-CPU boots peripheral devices of a main CPU, and establishes a path for accessing a memory of a main system. The sub-CPU reads a boot code of the main CPU from a portable memory mounted to a computer system, and moves it to the memory of the main system via the established path, and thereby, permits the main CPU to execute the boot code.

### CROSS-REFERENCE TO RELATED APPLICATIONS

This application is based upon and claims the benefit of priority from Japanese Patent Application No. 2006-023614, filed Jan. 31, 2006, the entire contents of which are incorporated herein by reference.

### BACKGROUND

1. Field

The present invention relates to a computer system having a subsystem for booting a main system.

2. Description of the Related Art

In a recent computer system, a boot program describing a series of procedures to be executed by a CPU for boots is previously written in a ROM, and the CPU executes the boot program in the actual boot. For example, the boot program is executed, and thereby, an operating system is read in a RAM from a disk drive. By doing so, there also exists a system executing a target program (user program). Conventionally, when we develop the computer system, the foregoing boot program is written in a programmable ROM, and thereafter, various operation tests are made.

Recently, it is general that a so-called multiprocessor system including several CPUs for the purpose of providing a high-speed multi-function system. For example, Jpn. Pat. Appln. KOKAI Publication No. 4-177452 discloses a computer system including the foregoing multiprocessor system. According to the disclosed Publication document, a predetermined CPU boots using data stored in a ROM. The predetermined CPU further reads data for booting another CPU from the ROM or other memory devices, and then, writes it in a shared memory. Thereafter, the CPU sends a boot signal to the foregoing another CPU. When receiving the boot signal, the CPU other than the predetermined CPU boots using data written in the common memory.

It is desired to readily change boot codes or target program in the development of the computer system. According to the foregoing Publication No. 4-177452, boot code only is recorded in the shared memory via the predetermined CPU, and then, the boot code is executed via another CPU. In general, the computer system includes several peripheral devices such as RAM, power unit and clock generator, in addition to CPU and ROM. In order to perform a system design change and to provide various type computer systems, it is desired to readily change various setups (parameters) of the foregoing peripheral devices.

Moreover, the development of the computer system requires the following point. For example, the content of a programmable ROM must be changed to change the boot code and/or target user program. The foregoing change needs to taken the following troublesome procedures. Specifically, a specific device such as ROM writer is used to change the content of the programmable ROM. Then, the ROM mounted to an IC socket must be replaced with a ROM having the changed content using a specific apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a computer system according to one embodiment of the present invention;

FIG. 2 is a flowchart to explain a first method of booting a main CPU;

FIG. 3 is a view showing a boot code information table including boot code, boot code attribute and address information;

FIG. 4 is a flowchart to explain a second method of booting the main CPU; and

FIG. 5 is a flowchart to explain a third method of booting the main CPU.

### DETAILED DESCRIPTION

Various embodiments according to the invention will be described hereinafter with reference to the accompanying drawings. In general, according to one embodiment of the invention, there is provided a method of booting a main system in a computer system including a main system having a main CPU, and a subsystem controlling the boot of the main system and having a sub-CPU, the sub-CPU executing the following operations of: booting peripheral devices of the main CPU; establishing a path for accessing a memory included in the main system; reading a boot code of the main CPU from a portable memory mounted to the computer system, and moving the boot code to the memory of the main system via the established path; and permitting the main CPU to execute the boot code.

According to the foregoing embodiment, various means for booting the main system are readily provided in the computer system including the main system and the subsystem.

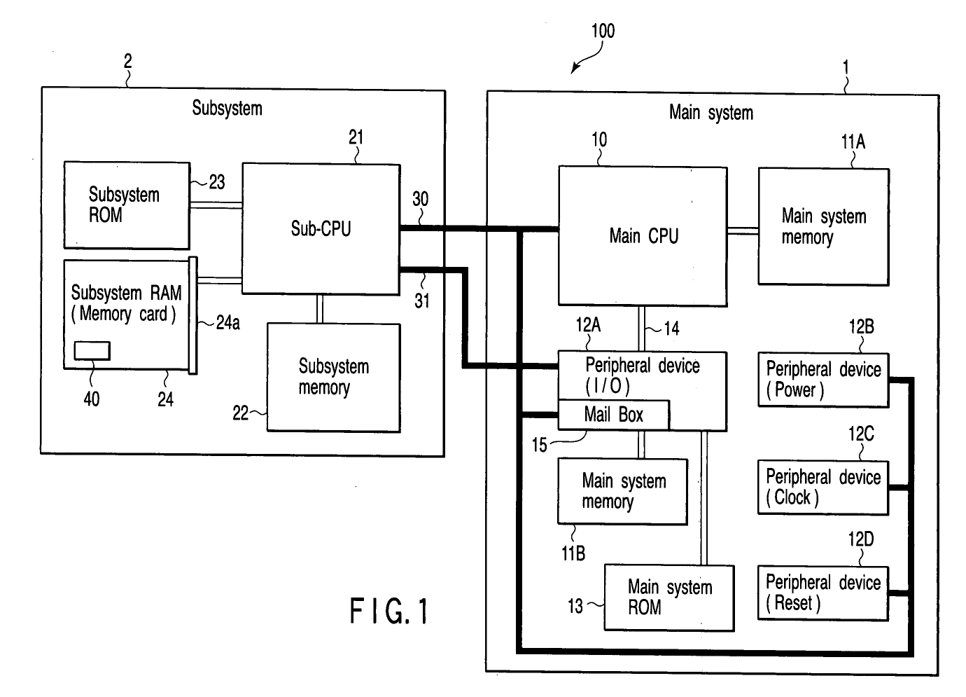

FIG. 1 is a block diagram showing the configuration of a computer system according to one embodiment of the present invention. A computer system 100 includes a computer system (main system) 1 having a main CPU 10. The computer system 100 further includes a sub-computer system (subsystem) 2 taking procedures power on reset described later) for booting the main system 1. The main system 1 and the subsystem 2 are a physically integrated hardware system. The main system 1 and the subsystem 2 are connected to each other via a serial bus (I2C, SPI) 30 and a parallel bus (PCI bus). The computer system 100 is applicable to the development of various electronic apparatuses such as electrical appliances and AV apparatuses.

The subsystem 2 controls peripheral devices making power control, reset control and clock control in the main system 1 via the serial bus 30. The subsystem 2 further controls data transfer between a main system memory and a subsystem memory via the parallel bus 31.

The main system 1 has a main system memory 11A serial-connected to the main CPU 10 and a main system memory 11b serial-connected to an I/O control peripheral device 12A. The main CPU 10 and the peripheral device 12A are connected via an I/O bus 14. The peripheral device 12A of the main system is connected with a main system ROM 13 to receive an access from the main CPU. The relationship of access speed between memories of the main CPU 10 is as follows. A relationship of memory access speeds of the main CPU 10 is “Main system memory 11A>Main system memory 11B>Main system ROM”. Peripheral devices 12B to 12D have functions of controlling power, clock and reset, respectively. Peripheral devices 12 to 12D and the main CPU 10 each have a serial bus interface controlled by a sub-CPU 21 of the subsystem 2. The peripheral device 12A a mailbox 15 used for communications between the main CPU 10 and the sub-CPU 12.

The subsystem 2 has a subsystem memory 22 serial-connected to a sub-CPU 21, a subsystem ROM 25, and further, a subsystem RAM (memory card) 24 removable from the subsystem body. The subsystem RAM 24 is mounted, that is, connected to the subsystem 2 via a card slot 24a. Moreover, the subsystem RAM 24 (memory card) has a file system usable to a PC (personal computer). Therefore, programs such as user program used for the system 100 and boot code are storable in the subsystem RAM 24 using the PC. In the subsystem 2, the sub-CPU 21 has built-in interface controllers (both are not shown) for the serial bus 31 and the parallel bus 32.

The following functions and operations are realizable using the foregoing configuration of the system.

(1) Method of Booting the System and Boot Code Load

In the system 100, a method of arranging a program (hereinafter referred to as boot code) for booting the main CPU 10 is used in the procedures for booting various devices of the system. The following method is employed as the method of arranging the program (boot code). The boot of the sub-CPU 21 of the subsystem 2 is realized in the following manner. Specifically, the sub-CPU 21 fetches boot code written in the subsystem ROM 23, and thereby, the boot is realized. According to the following method of booting the CPU 21, procedures taken by the sub-CPU are stored in the subsystem ROM 23 as a program, for example.

(1-1) Boot Using Boot Code Stored in Subsystem RAM (Subsystem Takes the Initiative)

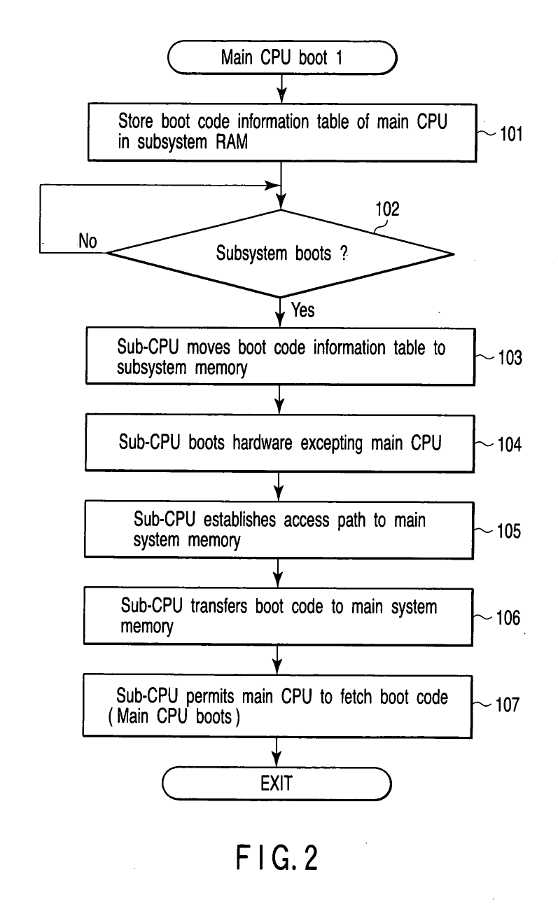

First, a method of booting the main CPU using boot codes stored in the subsystem RAM of the subsystem in a state that the subsystem takes the initiative will be described. FIG. 2 is a flowchart (main CPU boot 1) to explain the method of booting the main CPU.

The subsystem RAM 24 is previously stored with a CPU boot code information table (block 101). The boot code information table records a lot of information other than boot codes. For example, attribute information such as boot code size and address information are recorded. In this case, the address information expresses that boot code should be loaded anywhere on the main system.

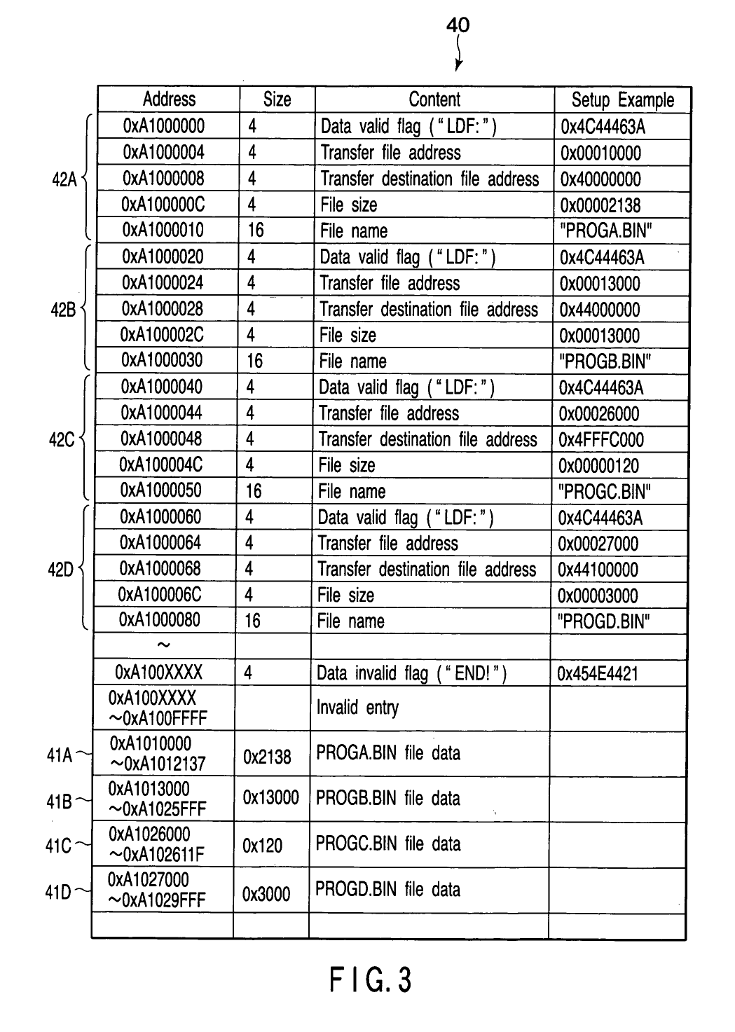

FIG. 3 shows one example of a boot code information table 40. In FIG. 3, the boot code information table 40 includes four boot programs 41A to 41D and associated information 42A to 42D related to each program. These programs 41A to 41D may be all given as boot code. Moreover, the programs 41A to 41D may be all given as one boot program and OS or program such as application program. Here, these 41A to 41D are all boot codes. For example, the associated information 42A shows the following information. Specifically, a file name is “PROGA.BIN”, a transfer file address is “0x00010000”, and a transfer destination file address is “0x40000000”. The transfer address is the address of the subsystem RAM 24, and shown as an offset value. On the other hand, a transfer destination address shows the address of the main system memory 11B.

The subsystem 2 boots when power is turned on (block 102). Then, the subsystem 2 reads the boot code information table 40 recorded in the subsystem RAM 24. According to the table 40, the subsystem 2 moves the boot code stored in the subsystem RAM 24 to the main system memory (block 103). Here, as seen from FIG. 3, address information is stored so that boot codes 41A to 41D stored in the subsystem RAM 24 are loaded to the main system memory 11B.

The sub-CPU 21 makes the following operation in order to load boot codes to the main system memory 11B of the main system 1. Specifically, the sub-CPU 21 boots hardware excepting the main CPU 10 of the main system 1 (block 104). That is, the hardware is power on (peripheral device 12B), clock boot (peripheral device 12C) and reset release (peripheral device 12D). Incidentally, the foregoing operation will be detailedly explained in the item (3) described later.

These hardware boots, and thereafter, the sub-CPU 21 initializes the peripheral device 12A connected to the main system memory 11B. In other words, the sub-CPU 21 opens the parallel 31 bus between the sub-CPU 21 and the peripheral device 12A to establish an access path to the main system memory 11B (block 105). As described above, the access path to the main system memory 11B is established via the parallel bus 31 and the peripheral device 12A. Thereafter, the sub-CPU 21 transfers the boot code stored in the subsystem RAM 24 to the main system memory 11B (block 106). In this case, the sub-CPU 21 uses the subsystem memory 22 as a boot code temporary buffer.

Boot code transfer to the main system memory 11B is completed. Thereafter, the sub-CPU permits the main CPU 10 to fetch the boot code (method of permitting the fetch will be described later in the item (4)). By doing so, the main CPU 10 boots, and then, starts to fetch the boot code loaded on the main system memory 11B (block 107).

[Effect]

According to this embodiment (1-1), a main CPU program has no need to be stored in the main system ROM 13. Moreover, the subsystem RAM 24 is used, and thereby, the program is readily updated using PC, for example. Therefore, this embodiment is effective to a boot code development phase (development initial stage). Likewise, the parallel bus of the peripheral device 12A and the main system memory 11B is initialized in a state that the sub-CPU takes the initiative. Therefore, this embodiment is effective to an initialization program development phase. In addition, this embodiment is effective to a development phase such that after the system boots, a user program such as application program is transferred from the subsystem RAM 24 to the main system, and then, executed.

(1-2) Boot Using Boot Code Stored in Subsystem RAM (Main System Takes the Initiative)

A method of booting the main CPU 10 in a state that the main system 1 takes the initiative will be described below.

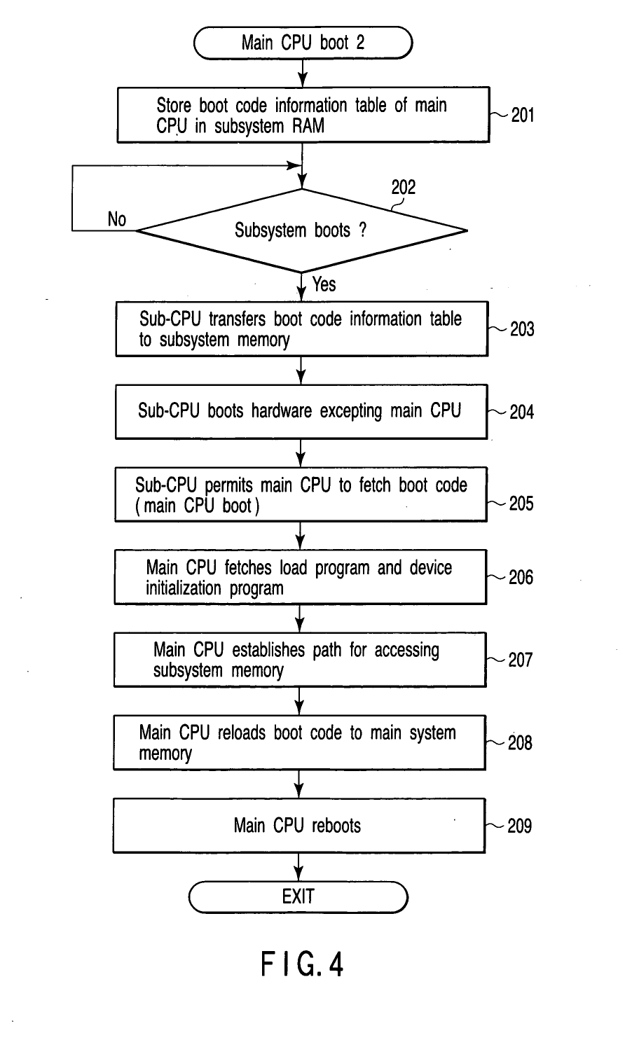

FIG. 4 is a flowchart (main CPU boot 2) to explain the method of booting the main CPU in a state that the main system takes the initiative.

The subsystem RAM 24 is previously stored with the same boot code information table 40 as the embodiment 1-1 (block 201). When the subsystem boots (block 202), the sub-CPU 21 transfers the boot code information table 40 recorded in the subsystem RAM 24 to the subsystem memory 22 (block 203). Then, the sub-CPU 21 boots hardware of the main system 1 in the manner as described above (block 204). Thereafter, the sub-CPU 21 permits the main CPU 10 to fetch the boot code (block 205).

In response to the fetch permission, the main CPU 10 first fetches device initialization program and load program stored in the main system ROM 13 (block 206). Then, the main CPU 10 initializes the peripheral device 12A according to the device initialization program to open a parallel bus (PCI bus) 31 between the peripheral device 12A and the sub-CPU 21. By doing so, a path between the peripheral device 12A and the main system memory 11B is established. In other words, the main CPU 10 establishes a path for accessing the subsystem memory 22 (block 207).

According to the load program, the main CPU 10 refers to the boot code information table loaded on the subsystem memory 22. Then, the main CPU transfers the boot code to the corresponding address area to reload the boot code on the main system memory 11B (block 208). After the boot code is loaded, the load program gives instructions to jump to the boot code loaded on the main system memory 11B to the main CPU 10, and thereby, the main CPU 10 jumps to the loaded boot code and executes the boot code (block 209).

[Effect]

This embodiment (1-2) is effective as a pre-stage of finally transferring to a method (1-3) described later. Specifically, the main CPU 10 executes the device initialization program and the boot code load program, which are stored in the main system ROM 13. This is effective to finally confirming the boot of the boot code. Moreover, this embodiment is effective to a development phase such that after the system boots, a user program such as application program is moved or reloaded from the subsystem RAM 24 to the main system ROM, and then, executed.

The following two ways are given as the method that the main CPU 10 fetches and executes load program and device initialization program stored in the main system ROM 13.

(1-2-1) One is a method of all reading device initialization program and load program from the main system ROM 13. In general, ROM access is low speed; therefore, according to this method, program execution speed is relatively late.

(1-2-2) Another is a method of rearranging mainly the load program of the foregoing two programs from the main system ROM 13 to the main system memory 11B and executing it. After fetch permission is given, the main CPU 10 executes the device initialization program stored in the main system ROM 13 to establish a path between the peripheral device 12A and the main system memory 11B.

Thereafter, the main CPU 10 reloads the load program from the main system memory ROM 13 to the man system memory 11B. Then, the main CPU 10 jumps to the load program on the main system memory 11B according to the instructions, and executes the load program. According to this method, the load program is executable at a high speed as compared with the case of accessing the main system ROM 13 and executing the load program.

(1-3) Boot Using Boot Code Stored in Main System ROM 13

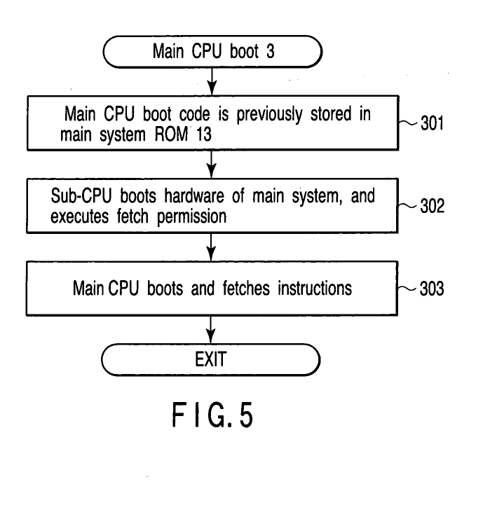

FIG. 5 is a flowchart (main CPU boot 3) to explain a method of booting main CPU using boot code stored in main system ROM 13.

In this case, the boot code is not moved between the subsystem and the main system unlike embodiments 1-1 and 1-2. Boot code of the main CPU 10 is previously stored in the main system ROM 13 (block 301).

The system boot procedure is as follows. The subsystem boots, and thereafter, the sub-CPU 21 boots hardware of the main system 1, and then, executes fetch permission of the main CPU 10 (block 302). The main CPU 10 fetches instructions from the main system ROM 13, and then, boots (block 303).

In this case, the boot code is not moved between the subsystem 2 and the main system 1 as described above. Therefore, there is no need of executing load program and device initialization program before boot code boots unlike the embodiment 1-2. In order to make high boot code execution speed, the method shown in 1-2-2 is used together to load the boot code to the main system memory 11B, and boot it. In this case, the device initialization program is stored in the main system ROM 13, and then, the main CPU executes the program.

[Effect]

The method described in the embodiment (1-3) is effective as a boot method after development is completed. Specifically, it is effective after confirming stable operation of boot code for booting the main CPU 10 or application program.

(2) Load of User Program After System Boots to Main System Memory 11A

The foregoing methods 1-1 and 1-2 or 1-3 and 1-2-2 are combined. According to this combination, the boot code is loaded to the main system memory 11B (from subsystem RAM 24 to memory 11B in the cases of 1-1 and 1-2, and from main system ROM 13 to memory 11B in the case of 1-3). By doing so, when the system boots, according to the boot code, user program such as application programs loaded to the main system memory 11B is transferred and reloaded to the main system memory 11A. In this case, the boot code includes instructions that the main CPU 10 jumps to program on the main system memory 11A. In the manner described above, the user program is previously stored in the subsystem RAM 24, and thereby, the main system 1 can execute the user program.

[Effect]

According to this embodiment (2), after the system boots, the user program is loaded to the main system memory 11A. Thus, the memory access speed becomes high; therefore, the user program is executed at a high speed.

(3) Hardware Boot of Main System 1 (Execution of Power-On Reset Control)

The main system having the main CPU needs to take the following procedures to execute power-on reset control.

a. Power on (main CPU, peripheral devices, etc.)

b. Cancel (release) of reset signal (peripheral devices are supplied with a reset signal when power is turned on)

c. Clock oscillation by initializing clock device

d. Initialization of high-speed communication interface between main CPU 10 and peripheral devices (CPU 10, peripheral device 12A, main system memory 11A, etc.)

e. Initialization of physical, data link and logical layers (layer is given as hardware)

f. Establish high-speed data communication by data link layer calibration

g. Initialization of main CPU 10 (initialization data write)

The subsystem controls the foregoing procedures; as a result, the main CPU 10 reads the boot code from peripheral device, and then, is capable of booting. Moreover, the power-on reset control is executable in stop and reset control of the system during operation in addition to system initial power-on.

(3-1) Power-On Reset Control by Subsystem

The following is a description of a power-on reset control program (hereinafter, referred to as POR control program) for booting hardware of the main system 1 by the subsystem 2. The power-on reset control corresponds to the procedures of blocks 104 and 204.

In order to boot hardware of the main system 1, devices must be controlled via a large number of steps described above. Device control is physically accessed via serial bus such as I2C and SPI.

In the developing stage of the main system 1, various changes are given. For example, control parameters are changed by a hardware specification change. A system operation specification is changed (e.g., operating frequency of main CPU 10, memory size of main system memory 11A, change of voltage value in power control). In order to flexibly undergo a change of setup parameters, the POR control program is provided. According to the POR control program, setup information to devices is acquired via a script program described in a file independently prepared from the POR control program.

The POR control program is transferred and loaded from subsystem ROM 23 or subsystem RAM 24 to subsystem memory 22 after the sub-CPU boots. This is executed by the sub-CPU 21. The sub-CPU 21 reads the script program from the file according to the POR control program. Based on the script program, the sub-CPU 21 executes parameter setup (register write) and state acquisition (register read) of main CPU 10 of the main system and peripheral devices 12A to 12D via access using serial bus interface.

During POR control, if the main CPU 10 of the main system has inherent information (different every CPU), the inherent information is usable as a POR control parameter. For example, in a case that proper voltage setup values of the main CPUs are various, if the setup value information is individually recorded in the main CPU, the subsystem reads the information. Then, according to the POR control program, the voltage setup value of the main CPU is set to a proper voltage using the peripheral device 12D based on the setup value information.

The main CPU 10 of the main system 1 and peripheral devices are controlled according to a series of script programs described in the file. By doing so, the foregoing power-on reset control is realized.

The file including the script program is stored in the subsystem RAM 24, and read according to the POR control program of the subsystem ROM 23. Finally, the system development is completed, and parameter setup values to devices of the main system 1 are determined. In this case, the script program is not read from the file of the subsystem RAM 24, but a parameter setup value is incorporated in the POR control program. By doing so, a POR control sequence is realized.

(4) Communication Method Between Main CPU and Sub-CPU

During the foregoing power-on reset control or after the main system boots, the peripheral device 12A is used in order to give system state and event notification from the main CPU 10 to the subsystem. A location for storing data used for information communication using the peripheral device 12A calls Mail Box. A Mail Box 15 is actually a several K-byte writable/readable register or memory built in the peripheral device 12A. The subsystem 2 recognizes the state of the main system from information recorded in the Mail Box 15. On the other hand, the main CPU 10 recognizes the state of the subsystem and gives event notification using the Mail Box 15.

(4-1) Main CPU Boot Permission Event

During the power-on reset control described in (3), the main CPU 10 becomes a state capable of booting, and can fetch instructions from main system ROM 13 or main system memory 11B. However, there is arisen the case described below. Specifically, it is desired to inhibit the main CPU from executing boot code or program until the power-on reset control sequence by the subsystem is completed. (For example, initialization of the memory interface between main CPU and main system memory 11A is not completed.) In such a case, communications are made using the Mail Box 15. When giving fetch permission, the sub-CPU 21 writes a semantic code showing the fetch permission of the main CPU 10 in the Mail Box 15. Thus, the main CPU 10 waits for loop until the foregoing code is written in the Mail Box, and does not take the next procedure.

(5) System Control

Functions described in the foregoing (1) to (4) are used, and thereby, the following controls are realizable in the system 100 shown in FIG. 1.

(5-1) System Boot

When the subsystem 2 is powered on, the sub-CPU 21 boots, and then, the subsystem 2 becomes a state capable of executing the POR control program. A main system boot event is given (e.g., power on by remote controller, etc., either of software and hardware may be booted). Thus, the POR control program boots, and the main system also boots in a manner described in (3). The method of booting the main CPU 10 is realizable using the methods described in (1) and (4). Finally, the main system 1 executes procedures described in (2) to boot the whole of the system, and then, a target program is operated.

(5-2) System Stop/Power-Off Event

A main system stop or power-off event is given from a state that the system boots and operates as described in (5-1) (either of software and hardware may be booted). In this case, the subsystem has a need to give main system stop notification to the main CPU 10 executing the program. Here, the sub-CPU 21 gives the main system stop notification to the main CPU 10 using the Mail Box described in (4). Incidentally, notification excepting notification via Mail Box or interruption is usable. When receiving stop permission notification from the main CPU 10, the sub-CPU 21 executes a script program of executing main system power-off according to POR control program.

(5-3) Return of Main System 1 from Stop State (System Reboot)

In this case, the main system 1 only is in a state of being stopped, the subsystem 2 waits for executing the POR control program from a state after boots described in (5-1). The main system boot event is given, and thereafter, the subsystem takes the same procedure as described in (5-1).

(5-4) Reset of Main System 1 from System Boot State and System Reboot

After the main system 1 boots as descried in (5-1), a reset event may be given to the main system 1. When detecting the reset event, the sub-CPU 21 executes a script program of controlling a reset control device (i.e., peripheral device 12D) of the main system 1.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of booting a main system in a computer system including a main system having a main CPU, and a subsystem controlling the boot of the main system and having a sub-CPU, the sub-CPU executing the following operations of:
booting peripheral devices of the main CPU;
establishing a path for accessing a memory included in the main system;
reading a boot code of the main CPU from a portable memory mounted to the computer system, and moving the boot code to a memory of the main system via the established path; and
permitting the main CPU to execute the boot code.

2. The method according to claim 1, wherein the sub-CPU transfers a user program executed by the main CPU to the main system memory together with the boot code, and
the boot code includes instructions that the main CPU jumps to the user program on the main system memory.

3. The method according to claim 1, wherein the portable memory is a memory card.

4. The method according to claim 1, wherein the computer system includes a data storage used in common when making communications between the main CPU and the sub-CPU, the sub-CPU writes a notification showing the boot code execution permission in the data storage, the main CPU reads the written notification, and thereby, the main CPU determines whether the boot code should be executed.

5. A method of booting a main system in a computer system including a main system having a main CPU, and a subsystem controlling the boot of the main system and having a sub-CPU, the sub-CPU executing the following operations of:
transferring a boot code stored in a portable memory and for booting the main CPU from the portable memory to a memory of the subsystem;
booting peripheral devices of the main CPU; and
permitting the main CPU to fetch the boot code,
the main CPU executing the following operations of:
establishing a path for accessing a memory of the subsystem;
transferring the boot code from the memory of the subsystem to a memory of the main system via the established path; and
executing the boot code transferred to the memory of the main system.

6. The method according to claim 5, wherein the sub-CPU transfers a user program executed by the main CPU to the main system memory together with the boot code, and
the boot code (program?) includes instructions that the main CPU jumps to the user program on the main system memory.

7. The method according to claim 5, wherein the portable memory is a memory card.

8. A computer system comprising a main system having a main CPU, a memory, and peripheral devices controlled by the main CPU, and a subsystem controlling the boot of the main system and having a sub-CPU,
the subsystem including:
booting unit configured to boot peripheral devices of the main CPU;
establishing unit configured to establish a path for accessing a memory included in the main system;
mounting unit configured to mount a portable memory
reading unit configured to read a boot code of the main CPU from the portable memory mounted to the mounting unit, and moving the boot code to a memory of the main system via the established path; and
permission unit configured to permit the main CPU to execute the boot code.

9. The computer system according to claim 8, further comprising:
communication unit configured to make communications between the main CPU and the sub-CPU; and
a data storage used in common when the communication unit makes communication between the main CPU and the sub-CPU,
the permission means writing a notification showing the boot code execution permission in the data storage, the main CPU reading the written notification, and thereby, the main CPU determining whether the boot code should be executed.
